(19) United States
(12) Patent Application Publication
(10) Pub. No.: US 2019/0003662 A1
(43) Pub. Date: Jan. 3, 2019

(54) THREE-WIRE LAMP STRING

(71) Applicant: Wenqiang DENG, Sichuan (CN)

(72) Inventor: Wenqiang DENG, Sichuan (CN)

(21) Appl. No.: 15/678,122

(22) Filed: Aug. 16, 2017

(30) Foreign Application Priority Data
Jun. 29, 2017 (CN) 201710513653.3
Jun. 29, 2017 (CN) 201720771883.5

(51) Int. Cl. F21S 4/10; H01R 12/62

(52) U.S. Cl. CPC F21S 4/10; F21Y 2113/13; H01R 12/62

(57) ABSTRACT

Disclosed is a three-wire lamp string in the technical field of colored lamps. The three-wire lamp string comprises three wires and a plurality of lamp beads, wherein the lamp beads are fixed to the three wires respectively, at least one chip is arranged in each lamp bead, and the two ends of each chip are connected with any two wires of the three wires. Lamp beads in various colors can be mounted, so that the displaying of colored lamps in various colors is achieved; by arranging the lamp beads in various colors in a crossed mode, the service types of the lamp beads in various colors are greatly broadened, and the displaying effect is good; meanwhile, compared with an existing four-wire lamp string, the three-wire lamp string of the invention is low in production cost, and the circuit failure rate is greatly decreased.

### BACKGROUND OF THE INVENTION

The invention relates to the technical field of colored lamps, in particular to a three-wire lamp string.

Colored lamps have various styles, can emit colorful flashing lamplight and have extremely good illuminating and decorating effects at night, thereby becoming the first choice of people for enhancing the festive atmosphere in festivals. Most existing colored lamps are formed by connecting lamps in various colors in series and supplied with power by a power supply through a driving circuit so as to emit light. The colored lamps can meet the requirements of users to a certain extent.

Most existing colored lamps are each formed by two wires so that displaying of lamps in only one color can be achieved, and the displaying effect is poor; for displaying more colors conveniently, four wires are generally adopted to achieve displaying of colored lamps in different colors at present, however, a lamp string of the structure is high in cost.

The above defects need to be overcome.

### BRIEF SUMMARY OF THE INVENTION

For overcoming the defects of the prior art, the invention provides a three-wire lamp string.

The technical scheme of the invention is as follows:

A three-wire lamp string is characterized by comprising three wires and a plurality of lamp beads, wherein the lamp beads are fixed to the three wires respectively, at least one chip is arranged in each lamp bead, and the two ends of each chip are connected with any two wires of the three wires.

According to the above scheme of the invention, the three-wire lamp string is characterized in that only one copper wire is arranged in each of the three wires.

According to the above scheme of the invention, the three-wire lamp string is characterized in that each of the three wires is formed through binding and winding of two or more copper wires.

According to the above scheme of the invention, the three-wire lamp string is characterized in that the three wires are all plastic rubber wires.

According to the above scheme of the invention, the three-wire lamp string is characterized in that the three wires are all plastic copper wires.

According to the scheme of the invention, the three-wire lamp string is characterized in that a gap is reserved between every two adjacent wires of the three wires.

According to the above scheme of the invention, the three-wire lamp string is characterized in that every two adjacent wires of the three wires are in contact connection.

According to the scheme of the invention, the three-wire lamp string has the beneficial effects that lamp beads in various colors can be mounted, so that displaying of colored lamps in various colors is achieved; by arranging the lamp beads in various colors in a crossed mode, the service types of the lamp beads in various colors are greatly broadened, and the displaying effect is good; meanwhile, compared with an existing four-wire lamp string, the three-wire lamp string of the invention is low in production cost, and the circuit failure rate is greatly decreased.

### BRIEF DESCRIPTION OF THE DRAWINGS

FIG. 1 is a structural schematic diagram of the invention;

FIG. 2 is a structural schematic diagram of the interior of lamp beads of the invention;

FIG. 3 is a side sectional view of a first embodiment of the invention;

FIG. 4 is a side sectional view of a second embodiment of the invention;

FIG. 5 is a side sectional view of a third embodiment of the invention; and

FIG. 6 is a side sectional view of a fourth embodiment of the invention.

In FIG. 10, lamp bead; 11, chip; 21, first wire; 22, second wire; 23, third wire.

### DETAILED DESCRIPTION OF THE INVENTION

A further description of the invention is given as follows with accompanying drawings and embodiments:

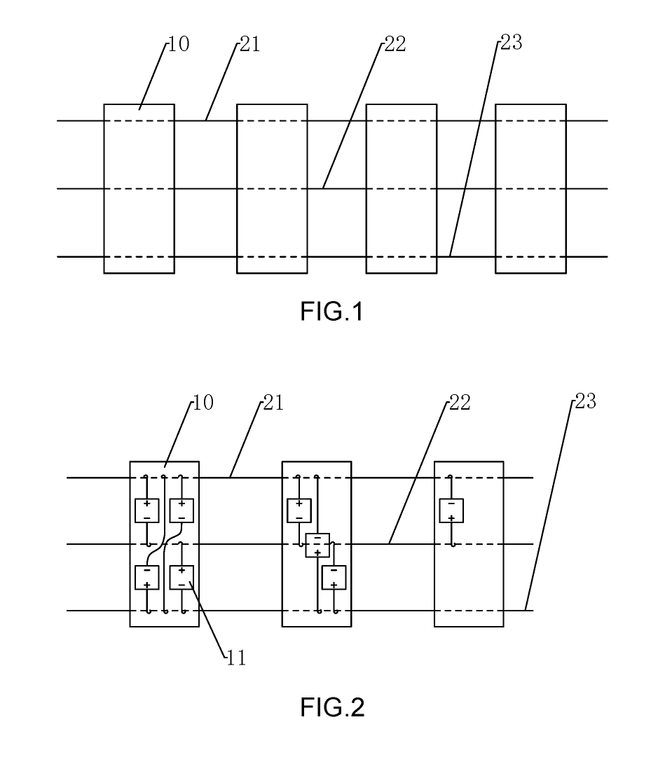

As is shown in FIGS. 1-2, a three-wire lamp string comprises three wires and a plurality of lamp beads 10, wherein the lamp beads 10 are fixed to the three wires respectively. In the embodiment, the three wires include the first wire 21, the second wire 22 and the third wire 23 respectively, a plurality of lamp beads 10 are arranged on the first wire 21, the second wire 22 and the third wire 23, the lamp beads 10 are fixedly connected with the three wires respectively, and the first wire 21, the second wire 22 and the third wire 23 extend side by side.

The three wires are connected with a control box, on-off of the three wires and the polarity setting modes of the three wires are controlled through the control box, and at least two of the three wires are connected with the positive electrode and the negative electrode respectively. In the field, the three wires can be arranged in various non-polarity setting modes such as a positive electrode-positive electrode-negative electrode mode, a negative electrode-positive electrode-positive electrode mode, a negative electrode-negative electrode-positive electrode mode, and a negative electrode-positive electrode-negative electrode mode, all the non-polarity setting modes accord with the overall concept of the invention, and connection and arrangement of colored lamps of the invention can be achieved.

At least one chip 11 is arranged in each lamp bead 10, the two ends of each chip 11 are connected with any two wires of the three wires, and the chips 11 with the two ends being connected with the positive electrode and the negative electrode of a power supply of the control box respectively emit light, and different chips 11 are made to emit light by controlling on-off and polarity setting of different wires.

One or more chips 11 are arranged in the same lamp bead 10, and the colors of the multiple chips 11 in each lamp bead 10 can be identical or different. The chips 11 in different colors emit light in different colors, and thus the number of colors displayed by the same lamp bead 10 is increased.

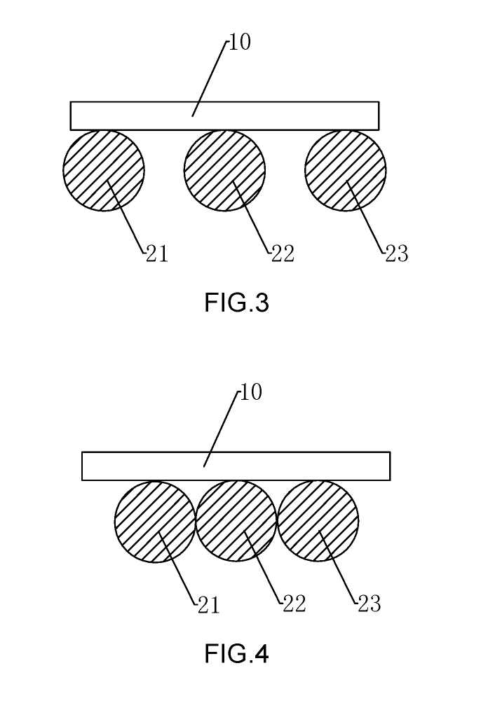

As is shown in FIGS. 3-4, in the first embodiment, only one copper wire is arranged in each of the three wires. In the three wires, a gap is reserved between every two adjacent wires, or every two adjacent wires are in contact connection.

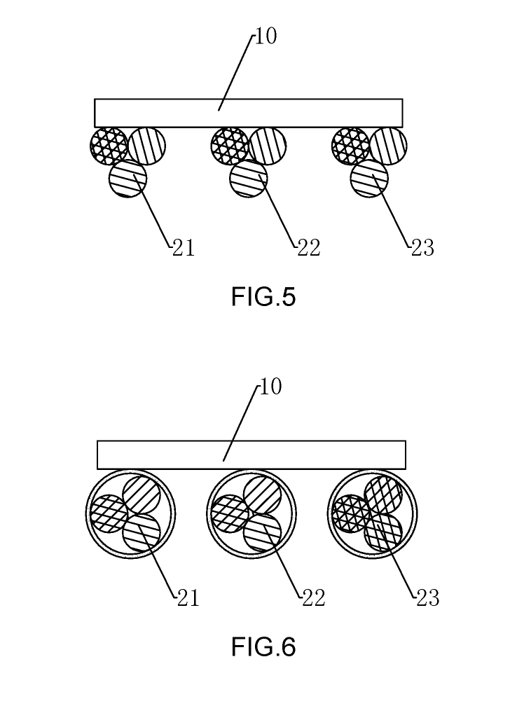

As is shown in FIG. 5, in the second embodiment, each of the three wires is formed through binding and winding of two or more copper wires.

As is shown in FIG. 6, in the third embodiment, the three wires are all plastic copper wires.

In the fourth embodiment, the three wires are all plastic rubber wires.

It should be understood that for those skilled in the field, improvements or transformations can be made according to the foregoing description, and all the improvements and transformations should be within the protection scope of the claims of the invention.

The foregoing illustrative description of the patent of the invention is given with the accompanying drawings, obviously, realization of the patent of the invention is not limited by the above execution modes, various improvements based on the method concept and technical scheme of the patent of the invention or direct applications of the concept and technical scheme of the patent of the invention to other occasions without improvements are within the protection scope of the invention.

1. A three-wire lamp string, characterized by comprising three wires and a plurality of lamp beads, wherein the lamp beads are fixed to the three wires respectively, at least one chip is arranged in each lamp bead, and the two ends of each chip are connected with any two wires of the three wires.

2. The three-wire lamp string according to claim 1, characterized in that a single copper wire is provided inside each of the three wires.

3. The three-wire lamp string according to claim 1, characterized in that each of the three wires is formed through binding and winding of two or more copper wires.

4. The three-wire lamp string according to claim 1, characterized in that the three wires are all plastic rubber wires.

5. The three-wire lamp string according to claim 1, characterized in that the three wires are all plastic copper wires.

6. The three-wire lamp string according to claim 1, characterized in that a gap is reserved between every two adjacent wires of the three wires.

7. The three-wire lamp string according to claim 1, characterized in that every two adjacent wires of the three wires are in contact connection.
